(19) United States
(12) Patent Application Publication
(10) Pub. No.: US 2018/0308047 A1
(43) Pub. Date: Oct. 25, 2018

(54) SYSTEMS AND METHODS FOR PERFORMING AUTOMATIC EXCHANGES OR RETURNS

(71) Applicant: XARIABLE, LLC, Columbus, OH (US)

(72) Inventors: David William Wardell, San Francisco, CA (US); Jonathan Paul Poma, Columbus, OH (US); Ryan Alexander Schuerger, Liberty Township, OH (US)

(21) Appl. No.: 15/955,709

(22) Filed: Apr. 18, 2018

Related U.S. Application Data
(60) Provisional application No. 62/488,012, filed on Apr. 20, 2017.

(51) Int. Cl. G06Q 10/08; G06Q 20/34; G06Q 30/06

(52) U.S. Cl. CPC G06Q 10/0837; G06Q 30/0631; G06Q 20/34

(57) ABSTRACT

The subject disclosure relates to employing components to facilitate an automated exchange or return operation are disclosed herein. In one example, a computer-implemented method can comprise receiving, by a system comprising a processor, first input information associated with a first merchandise item. The computer-implemented method can also comprise performing, by the system, an automatic return operation or an automatic exchange operation corresponding to the first merchandise item based on a comparison of the first input information to a set of business criteria. In another example, the method can further comprise sending, by the system, the at least one of another merchandise item to a second location based on receipt of a confirmation signal representing arrival of the merchandise item at the first location.

### CROSS-REFERENCE TO RELATED APPLICATION

This application claims priority to and claims the benefit of U.S. Patent Application No. 62/488,012, filed on Apr. 20, 2017 and entitled “Systems and Methods for Performing Automatic Exchanges or Returns”. The entirety of the disclosure of the aforementioned application is considered part of, and is incorporated by reference in, the disclosure of this application.

### FIELD OF USE

The subject disclosure relates to systems and methods for performing automatic exchange or return operations.

### BACKGROUND

Currently, consumers are transacting ever increasingly online and via electronic commerce platforms. As such, the demand for online consumer services is on the rise. As of now, consumers can browse and purchase items online with ease and from the convenience of their own home. Despite the pervasive availability of online shopping resources, consumers still must perform the process of returning and exchanging merchandise using antiquated means. For instance, a user may have to go to a physical store to return a merchandise item that does not fit or that they generally don't favor. Furthermore, in order to exchange an item for a new size, the consumer must first wait for the exchange transaction to occur by shipping an item to a vendor or physically returning the item to a store before they can obtain a new item in exchange for the returned item. As such, the issues related to current and outdated systems and methods for performing exchanges and returns of merchandise need to be overcome.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatus and/or computer program products that facilitate the automated performance of exchanging or returning merchandise items are provided.

According to an embodiment, a system is provided. The system comprises a memory that stores computer executable components; and a processor that executes the computer executable components stored in the memory. The computer executable components can comprise an input component that receives first input information associated with a first merchandise item. The computer executable components can also comprise a transaction component that performs an automatic return operation or an automatic exchange operation corresponding to the first merchandise item based on a comparison of the first input information to a set of business criteria. In another aspect, the computer executable components can further comprise an analysis component that compares the first input information to the set of business criteria to facilitate a determination of whether the first merchandise item is eligible for the automatic return operation or the automatic exchange operation.

In another embodiment, a computer-implemented method is provided. The computer-implemented method can comprise receiving, by a system comprising a processor, first input information associated with a first merchandise item. The computer-implemented method can also comprise performing, by the system, an automatic return operation or an automatic exchange operation corresponding to the first merchandise item based on a comparison of the first input information to a set of business criteria. In yet another aspect, the computer-implemented method can comprise comparing, by the system, the first input information to the set of business criteria to facilitate a determination of whether the first merchandise item is eligible for the automatic return operation or the automatic exchange operation.

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

FIG. 1 illustrates a block diagram of an example, non-limiting system that facilitates performing an automated exchange or refund operation in accordance with one or more embodiments described herein.

FIG. 2 illustrates a block diagram of an example, non-limiting system that facilitates performing an automated exchange or refund operation in accordance with one or more embodiments described herein.

FIG. 3 illustrates a block diagram of an example, non-limiting system that facilitates performing an automated exchange or refund operation in accordance with one or more embodiments described herein.

FIG. 4 illustrates a block diagram of an example, non-limiting system that facilitates performing an automated exchange or refund operation in accordance with one or more embodiments described herein.

FIG. 5 illustrates a block diagram of an example, non-limiting system that facilitates performing an automated exchange or refund operation in accordance with one or more embodiments described herein.

FIG. 6 illustrates a block diagram of an example, non-limiting system that facilitates performing an automated exchange or refund operation in accordance with one or more embodiments described herein.

FIG. 7 illustrates a block diagram of an example, non-limiting system that facilitates performing an automated exchange or refund operation in accordance with one or more embodiments described herein.

FIG. 8 illustrates a block diagram of an example, non-limiting system that facilitates performing an automated exchange or refund operation in accordance with one or more embodiments described herein.

FIG. 9 illustrates a block diagram of an example, non-limiting system that facilitates performing an automated exchange or refund operation in accordance with one or more embodiments described herein.

FIG. 10 illustrates a block diagram of an example, non-limiting system that facilitates performing an automated exchange or refund operation in accordance with one or more embodiments described herein.

FIG. 11 illustrates a block diagram of an example, non-limiting system that facilitates performing an automated exchange or refund operation in accordance with one or more embodiments described herein.

FIG. 12 illustrates a block diagram of an example, non-limiting system that facilitates performing an automated exchange or refund operation in accordance with one or more embodiments described herein.

FIG. 13 illustrates a block diagram of an example, non-limiting system that facilitates performing an automated exchange or refund operation in accordance with one or more embodiments described herein.

FIG. 14 illustrates an example non-limiting embodiment depicting a method for facilitating an automated exchange or refund operation in accordance with one or more embodiments described herein.

FIG. 15 illustrates an example non-limiting embodiment depicting a method for facilitating an automated exchange or refund operation in accordance with one or more embodiments described herein.

FIG. 16 illustrates an example non-limiting embodiment depicting a method for facilitating an automated exchange or refund operation in accordance with one or more embodiments described herein.

FIG. 17 illustrates an example non-limiting embodiment depicting a method for facilitating an automated exchange or refund operation in accordance with one or more embodiments described herein.

FIG. 18 illustrates an example non-limiting embodiment depicting a method for facilitating an automated exchange or refund operation in accordance with one or more embodiments described herein.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and devices are shown in block diagram form in order to facilitate describing the innovation. Furthermore, the following detailed description is merely illustrative and is not intended to limit embodiments and/or application or uses of embodiments. Furthermore, there is no intention to be bound by any expressed or implied information presented in the preceding Background or Summary sections, or in the Detailed Description section.

By way of introduction, the subject matter disclosed in this disclosure provides systems, methods and devices to facilitate an automated return operation or exchange operation. In an aspect, the disclosure describes a computer-implemented system that allows a user to return any item ordered online. The user can select an item for return, identify the reason for returning such item, and select an exchange action such as exchange the item for an item of a new style, a gift card, or merely perform a refund. The system allows users to seamlessly perform a variety of exchange or return operations associated with various ordered items while using a respective vendor website to perform other activities such as browsing and purchasing merchandise.

Many vendor websites do not offer exchange or return capabilities to consumers or use third party websites that disrupt an enjoyable user experience. However, the disclosed systems, methods, and devices integrate the return and exchange operations with other conventional functions available to consumers on a vendor website, which allows the user to continue experiencing the vendor's website, obtain positive return and exchange experiences, enhance the brand equity of the vendor, and provide seamless return and exchange features in accordance with consumer preferences. Furthermore, in the instance of a consumer performing a return operation, the disclosed system can allow the consumer to use the refund proceeds for other purchases on the vendor website.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

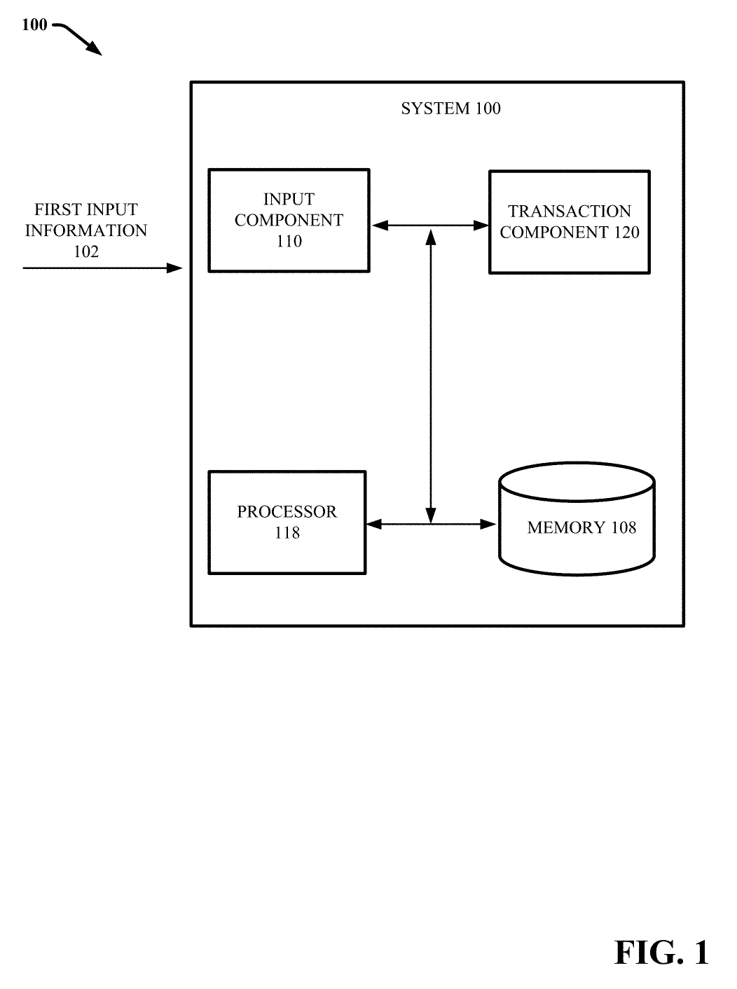

As shown in FIG. 1, illustrated is a block diagram of an example, non-limiting system 100 that can facilitate performance of a return or exchange operation in accordance with one or more embodiments described herein. In various non-limiting embodiments, system 100 can employ and store in memory 108 a return operation of a merchandise item or an exchange operation of a merchandise item. In another aspect, system 100 can be associated with or included in a data analytics system, an e-commerce platform, a data processing system, a graph analytics system, a graph processing system, a big data system, a social network system, a speech recognition system, a graphical modeling system, a data compression system, an artificial intelligence system, a machine-learning system, an authentication system, a syntactic pattern recognition system, a network system, a computer network system, a communication system, or the like.

Aspects of systems (e.g., system 100 and the like), apparatuses, or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described herein. As shown in FIG. 1, illustrated is system 100 that can comprise input component 110 and transaction component 120. The system components can also include or otherwise be associated with at least one processor 118 that can execute the computer executable components and/or computer instructions stored in memory 108. In an aspect, the input component 110, executed by processor 118, receives first input information associated with a first merchandise item.

The first input information can represent data associated with order details for a merchandise item. For instance, the processor 118 can execute input component 110 to receive first input information including the merchandise item details (e.g., serial number, item type, item size, item color, item brand, etc.), purchase details (e.g., date of purchase, purchase price, discounts or coupons applied, payment method used, etc.), user information (e.g., username, password, e-mail address, physical address, etc.), or other such details associated with a transaction. Furthermore, in an aspect, the system 100 can employ processor 118 to execute transaction component 120 that can perform an automatic return operation or an automatic exchange operation corresponding to the first merchandise item based on a comparison of the first input information to a set of business criteria.

The execution of transaction component 120 by processor 118 allows for a user to return or exchange any merchandise item from a previous order. The user can select an item for return, input the reason for performing a return of the merchandise item, and determine whether to exchange the merchandise item for a new merchandise item, exchange the merchandise item for a gift card, or return the merchandise item for a monetary refund. The transaction component 120 can facilitate the performance of a return operation and/or an exchange operation to be executed by processor 118 of system 100 based on a comparison of the first input information to a set of business criteria.

In an aspect, the business criteria can include a set of rules implemented by the system administrator (e.g., vendor, seller of the merchandise items, user with administrator credentials, etc.) where such rules represent criteria for the qualification of merchandise items for return operations and/or exchange operations. As such, the rules can govern whether or not a merchandise item or requested transaction is eligible for a return or exchange operation respectively. For instance, a system administrator may deem a merchandise item purchased as per a “final sale” event or other such promotional event ineligible for a refund but eligible for an exchange of a particular size of the same merchandise item. In such instance, the administrator can implement such business criteria or delineated rules using transaction component 120. In another instance, an administrator may wish to allow for some merchandise items to be refunded as a gift card or via a reward system requiring expenditure of such proceeds at a particular vendor establishment. Accordingly, transaction component 120 can compare the information received by input component 110 to the business criteria to determine whether the merchandise item is eligible (based on whether the information satisfies the business criteria) for an exchange or refund.

In an aspect, system 100 can comprise exchange and return functions displayed to a user as a seamlessly integrated component of a vendors existing system architecture or vendors e-commerce platform. For instance, upon a user utilizing system 100 to select whether to exchange or refund a merchandise item, the user can be directed to the vendor system to browse for the same or different merchandise items in accordance with the return or exchange operation. As such, the return and exchange system 100 can be customized to mimic the layout and design of the vendor's website system and communicatively couple to the vendor website components as well. For instance, if a user selects a new merchandise item for an exchange operation from the vendor website, then system 100 can receive such selected data associated with the user input information and facilitate the exchange operation given the selected merchandise item satisfies respective business rules or business criteria. Thus a user can browse and shop on a vendors' website for a desired merchandise item (e.g., new style, new color, new item, etc.) thereby receiving a desired e-commerce experience provided by the vendors known website functions while also accomplishing a return or exchange activity relating to a respective merchandise item without disturbing the e-commerce experience expected from the vendor website.

In furtherance, of receiving a high quality customer experience, system 100 can also employ a manual (e.g., via a customer experience representative) or automated refund function conducted by the vendor to refund an amount of money to a customer-user if the chosen return merchandise item is priced more than the new exchanged merchandise item. In an aspect, the manual exchange can occur when the exchanged merchandise item is verified to be received by the merchant or verified that shipping of the item has occurred. In another aspect, if a merchandise item for exchange is more expensive than the original merchandise item, then a user can pay the difference using system 100 as well. Accordingly, system 100 provides an integrated component for vendors, e-commerce platforms, and other such users to facilitate return and exchange operations relating to its merchandise items in collaboration with its own e-commerce platform.

As such, system 100 not only facilitates the return and exchange of merchandise items (e.g., sending merchandise back to a vendor) but also allow a user to obtain new merchandise (e.g., shop the vendor platform for a new merchandise item) as an immersive inline exchange experience. The system 100 can create a refund or exchange order associated with each requested return or exchange item and provide such refund or exchange order to the vendor (e.g., company, client, website, store, etc.) and/or the user to facilitate an automated exchange mechanism. The system 100 acts as an extension of the vendor's e-commerce website or platform such that a user can perform an exchange or return operation within the vendor's purview. Furthermore, in accordance with an administrative business rule allowing for prioritization of exchange orders, system 100 can prioritize exchange or refund orders to the top (or at other locations within the list) of the vendor's list of outstanding exchange orders. In another aspect, system 100 can employ a component allowing a user to browse a vendor's website or e-commerce platform to select a replacement item (in a refund or exchange scenario) and allow for the automatic shipment of the item as well as a refunding of payment to occur in a turnkey manner. The system 100 can perform refund, exchange, and automatic shipping operations in accordance with qualified business rules and shipping rules.

In an aspect, system 100 empowers vendors to provide customers the ability to exchange a merchandise item before the merchandise item is sold out, placed on back-order, or prior to a product being shipped out. Furthermore, the integration of the exchange operation, refund operation, and shipping operations provides a vendor with a greater ability to fulfil the exchange order with the desired merchandise item given that the shipping carriers system infrastructure can be interlinked and correspondently connected with the exchange system (e.g., all communication and network functions can be connected to system 100). In another aspect, a shipping carrier API can be integrated into system 100 to allow for an embedded exchange of information and data related to shipping and exchange activities.

Furthermore, system 100 enables a vendor to save time on shipping matters and exchange matters as well as effectively monitor inventory assets in association with shipping, returns, and exchange activities. Accordingly, system 100 can allow for the exchange of a new size or style to a customer-user in real-time based on the availability of in-stock inventory (e.g., at a warehouse). In an aspect, system 100 can allow for a user to retrieve an exchanged item or associated refund of an item in real-time. For instance, system 100 can allow for an item to be refunded or an exchanged item to ship out to a user-specified location as soon as the returned item is received by the shipping carrier or at another designated point of time during the item retrieval process (e.g., another point along the delivery chain to verify sending or receipt of a returned/exchanged item).

The shipping operation can occur manually or in an automated manner. Furthermore, system 100 can be integrated into an e-commerce platform with one or more of the shipping features, return features, or exchange features. Therefore, system 100, by integrating all the functions (e.g., exchange operation, refund operation, repurchase operation, shipping of item by user, shipping of item by vendor/delivery party, etc.) associated with an exchange and refund, provides vendors and company's a turnkey system to facilitate consumer exchange and refunds embedded within the vendors own existing e-commerce platform. In another aspect, system 100 can be implemented in connection with an e-commerce return merchandise authorization system (RMA) of a vendor or serve as an integrated RMA solution to a vendor. Another benefit of system 100 is to provide an exchange and return tool to a vendor that is transparent to customers.

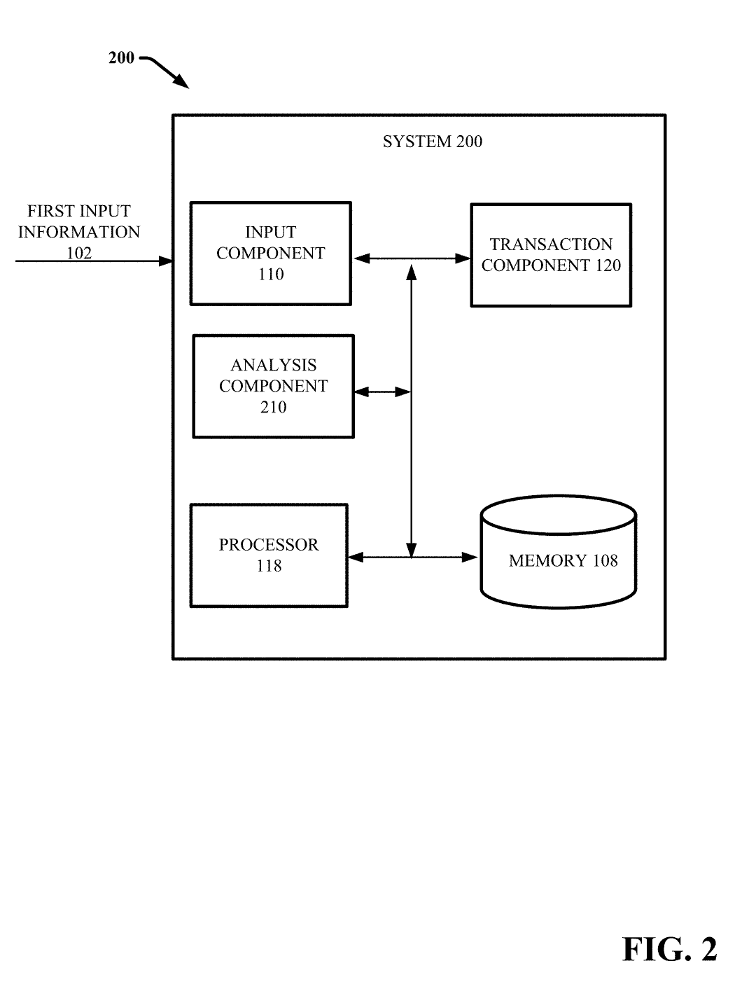

Turning now to FIG. 2, illustrated is system 200 in which an automated return or exchange system is described in accordance with one or more embodiments described herein. Repetitive description of like elements employed in other embodiments described herein are omitted for sake of brevity. In a non-limiting embodiment, system 200 can comprise an input component 110, a transaction component 120, and an analysis component 210 that can compare the first input information to the set of business criteria to facilitate a determination of whether the first merchandise item is eligible for the automatic return operation or the automatic exchange operation.

As described above, system 200 can perform a comparison (e.g., using analysis component 210) of first input information to a set of business criteria to facilitate a determination of whether the merchandise item associated with the first input information is eligible or ineligible for a return or exchange. The analysis component 210 can perform the comparative analysis between the first input information and business criteria to determine merchandise eligibility. In an aspect, the analysis component 210 can compare a set of business criteria or business rules within a rule engine to a set of input information. The set of input information can be organized in a hierarchical manner, ranked by priority or associated with a weighting scale, to identify information that takes precedent over other intake information in determining eligibility or ineligibility of a merchandise item for a return operation or exchange operation. Furthermore, input data can be stored in a database or table for access and comparison to business rules specific to a particular merchandise item.

In an aspect, analysis component 210 can compare input information such as the number of days since a product has been purchased, a requested mechanism for refund (e.g., credit, cash, gift card, replacement item), whether the merchandise item for refund or exchange is a digital product or an in-app purchase, the party to whom paid for shipping of the original merchandise item, or other such input information. Accordingly, analysis component 210 can compare such input information against a set of respective business rules or criteria such as, a rule stating a number of days allowable for a return or exchange from the date of merchandise purchase, a rule stating an allowable method of repayment or exchange (e.g., gift card only, item for item exchange, credit card refund, etc.), a rule identifying respective merchandise items that are eligible or ineligible for exchanges or returns (e.g., final sale items ineligible, digital products eligible, in-app purchases ineligible), or a rule that identifies whether shipping will be repaid or not repaid. Thus, analysis component 210 can analyze input information data stored in a system memory or database (e.g., using a data table) and compare such information to a set of business rule data to facilitate a determination of an eligibility of a merchandise item for return or exchange.

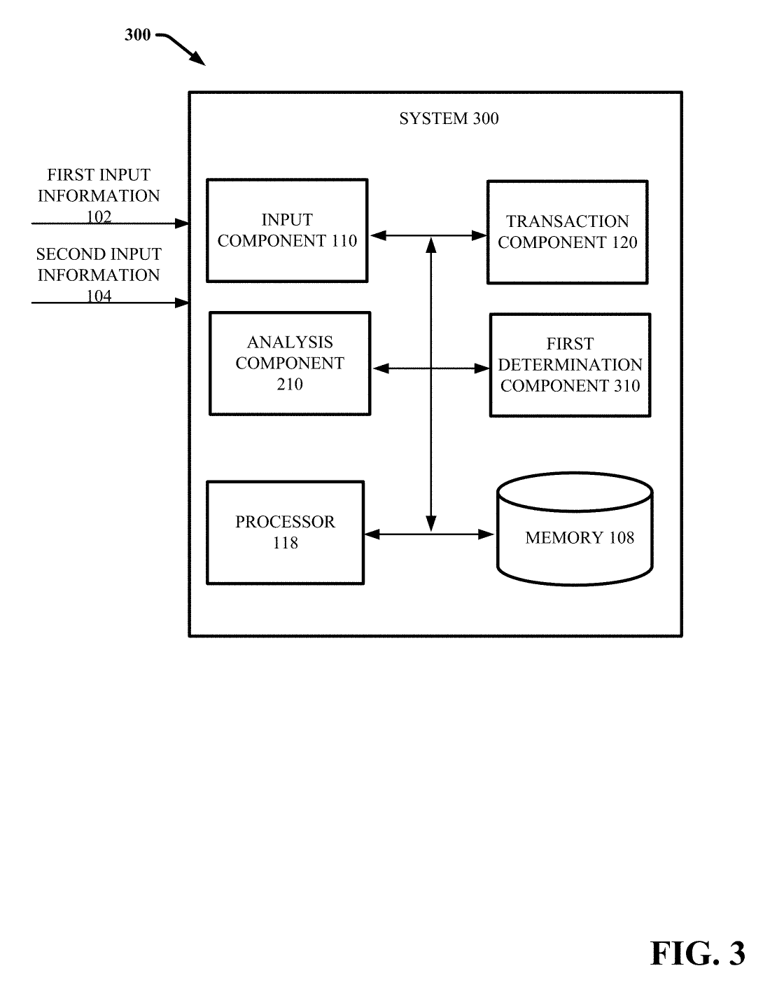

Turning now to FIG. 3, illustrated is system 300 in which an automated return or exchange system is described in accordance with one or more embodiments described herein. Repetitive description of like elements employed in other embodiments described herein are omitted for sake of brevity. In a non-limiting embodiment, system 300 can comprise an input component 110, a transaction component 120, an analysis component 210, and a first determination component 310 that can determine a first eligibility determination as to whether the first merchandise item is eligible for the automatic return operation or a second eligibility determination as to whether the first merchandise item is eligible for the automatic exchange operation based the comparison of the first input information to the set of business criteria.

In an aspect, determination component 310 can utilize the resultant data of the comparative analysis between input information and the business criteria data or business rule data to determine the eligibility of a merchandise item for an exchange or a return. Furthermore, the determination component 310 may consider a different subset of input information to determine exchange eligibility or return eligibility. For instance, the nature of the exchange or return may determine what type of information is pertinent for determining the eligibility of a particular exchange or return operation. As a non-limiting example, a user may seek to exchange a merchandise item for a new size or a new style of the merchandise item. As such, determination component 310 may determine an eligibility based on a comparison of the input information relating to inventory availability of a particular size or whether a different style of the merchandise item is comparatively the same price as the original style of the merchandise item. However, determination component 310 may determine an eligibility of the merchandise item for a refund based on different input information such as whether the customer is requesting a cash exchange, a gift card exchange, or a credit reimbursement exchange. Thus, a merchandise item in some instances can be determined to be eligible for an exchange but not a refund or vice versa as well.

Accordingly, the transaction component 120 in connection with the determination component 310 can perform a return operation or an exchange operation associated with a merchandise item. In an aspect, the transaction component 120 can perform the automatic return operation based on the first eligibility determination (e.g. using determination component 310) of the first merchandise item and second input information (e.g., user selection input as to a mechanism for refund such as online account, bank account, credit card, gift card, vendor reward points, in-platform credit, etc.). In yet another aspect, the transaction component 120 can perform the automatic exchange operation based on the second eligibility determination (e.g., using determination component 310) of the first merchandise item and third input information (e.g., user selection input relating to desired exchange requests such as an exchange for a new style, new size, another merchandise item, a new color, etc.) corresponding to another first merchandise item.

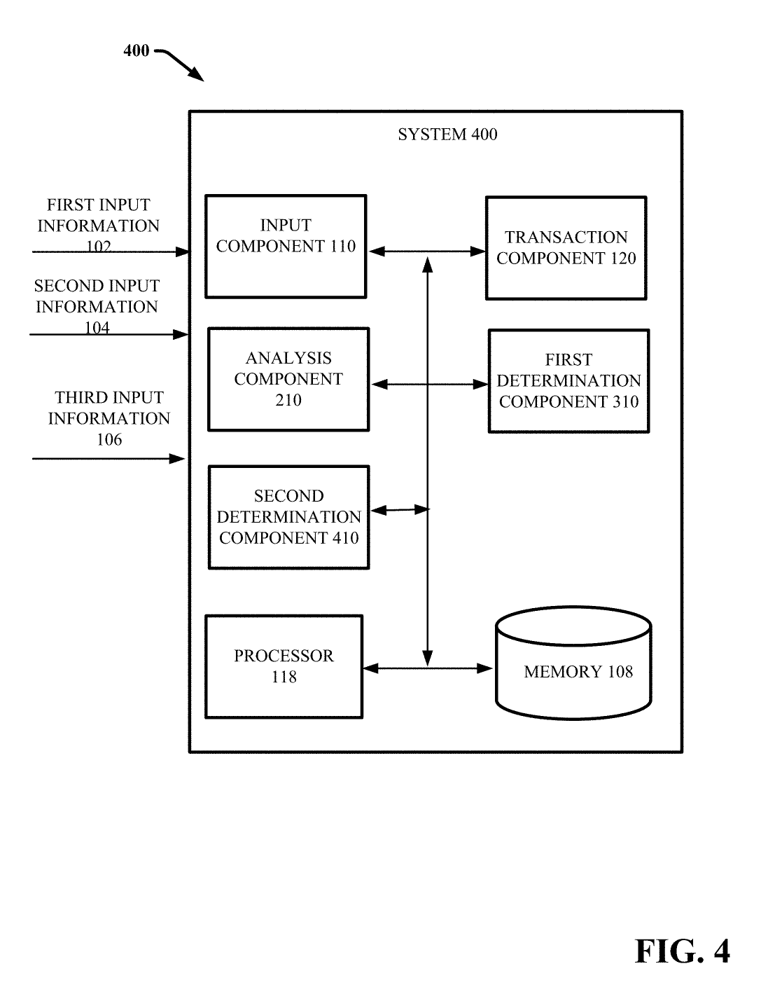

Turning now to FIG. 4, illustrated is system 400 in which an automated return or exchange system is described in accordance with one or more embodiments described herein. Repetitive description of like elements employed in other embodiments described herein are omitted for sake of brevity. In a non-limiting embodiment, system 400 can comprise an input component 110, a transaction component 120, an analysis component 210, a first determination component 310, and a second determination component 410 that can determine a first refund amount associated with the first merchandise item based on the first input information, wherein the first refund amount represents an amount paid for the first merchandise item.

In an aspect, second determination component 410 can determine an amount to refund a user account or user payment source based on various merchandise data. For instance, second determination component 410 can analyze a price associated with a first merchandise item requested for refund. The second determination component 410 can the determine an amount to refund based on the analyzed price. For instance, the second determination component 410 may determine that a refund can be granted to a client covering the purchase price, the tax levied on the first merchandise item, and the shipping costs incurred to the client. Furthermore, the second determination component 410 can make a determination based on user input data and business rules as to whether the refund should take the form of cash, credit, gift card, digital currency, reward points or other payment mechanisms.

In another aspect, second determination component 410 can determine a refund amount associated with an exchange operation of a merchandise item. For instance, in an aspect, the first merchandise item originally purchased may be requested to be exchange for a second merchandise item where the second merchandise item is cheaper than the first merchandise item. In such instance, second determination component 410 can determine an amount to refund (e.g., difference between the prices of the first merchandise item and second merchandise item) to the user. Furthermore, second determination component 410 can take into account whether a user has available credit (e.g., from previous returns) to shop for a new merchandise item and apply such credit to the purchase of the merchandise item in accordance with a user preference.

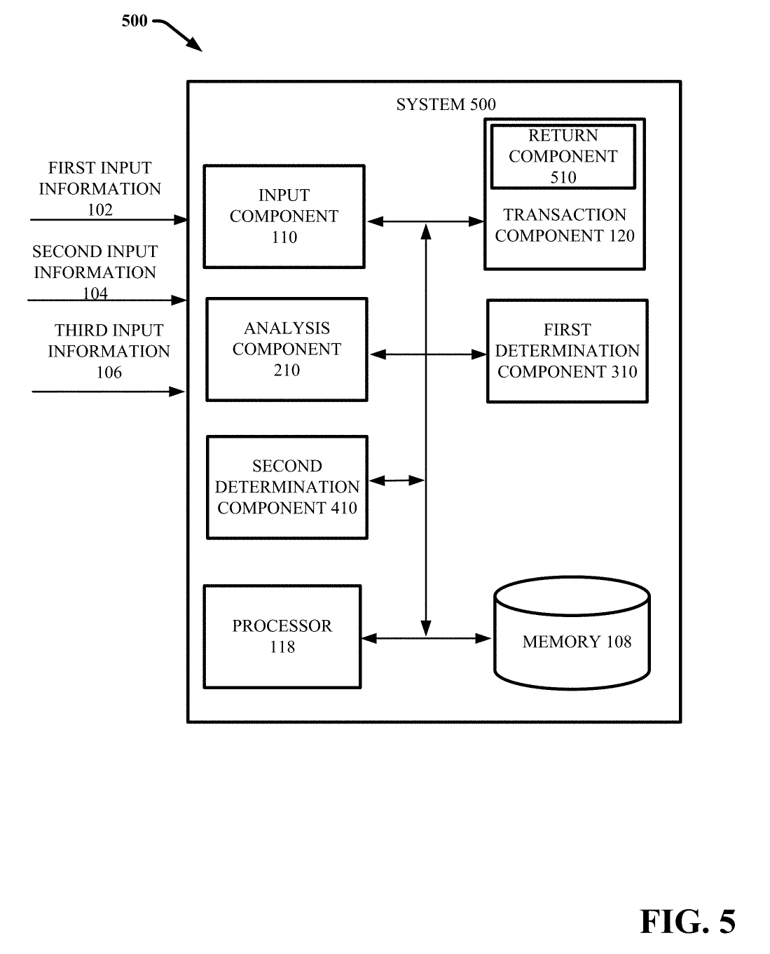

Turning now to FIG. 5, illustrated is system 500 in which an automated return or exchange system is described in accordance with one or more embodiments described herein. Repetitive description of like elements employed in other embodiments described herein are omitted for sake of brevity. In a non-limiting embodiment, system 500 can comprise an input component 110, a transaction component 120, an analysis component 210, a first determination component 310, a second determination component 410, and a return component 510.

The return component can perform a first version of the automatic return operation, a second version of the automatic return operation, or a third version of the automatic return operation based on third input information, wherein the first version of the automatic return operation represents selection of a second merchandise item, wherein the second version of the automatic return operation represents selection of a first return option of the first refund amount to a first payment instrument, and wherein the third version of the automatic return operation represents selection of a second return option of the first refund amount to a second payment instrument. In an aspect, the return component 510 in connection with the transaction component 120 can perform a number of refund options including refunding a user for a returned merchandise item using a gift card, using a credit card, using cash, or using any such mechanism for a determined (e.g., determined using second determination component 410) amount that includes the total merchandise item amount or a residual merchandise item amount (e.g., the difference between a newly a cheaper new merchandise item and the returned merchandise item).

As such, while the second determination component 410 determines an amount for refund, the refund component 510 can perform the refund operation. The first version of the automatic refund operation is a refund of money for a merchandise item that has been exchanged for a less expensive new merchandise item. The refund component 510 is responsive to second determination component 410 that determined an amount of money for refund. Thus, the refund component 510 can execute the refund operation of an amount determined by second determination component 410. In another aspect, refund component 510 can carry out a second version of the automatic refund operation where the determined refund amount (e.g., determined using second determination component 410) is refunded to a gift card or as reward points.

In an aspect, the vendor can accept gift cards or reward points to apply against the purchase of various merchandise items offered within its e-commerce platform. Also, system 500 can employ various features to accommodate a reward point mechanism that is acceptable to one or more vendors for use within its platform. Furthermore, a gift card refund can take the form of a prepaid card provided by the vendor with a stored amount of money (e.g., a card that can be reloaded) and the gift card can be digital, printable, or a physical card that is mailed to a user address. In yet another aspect, refund component 510 can employ a third version of the automatic refund operation which refunds the determined refund amount to a credit card, checking account, or via a check.

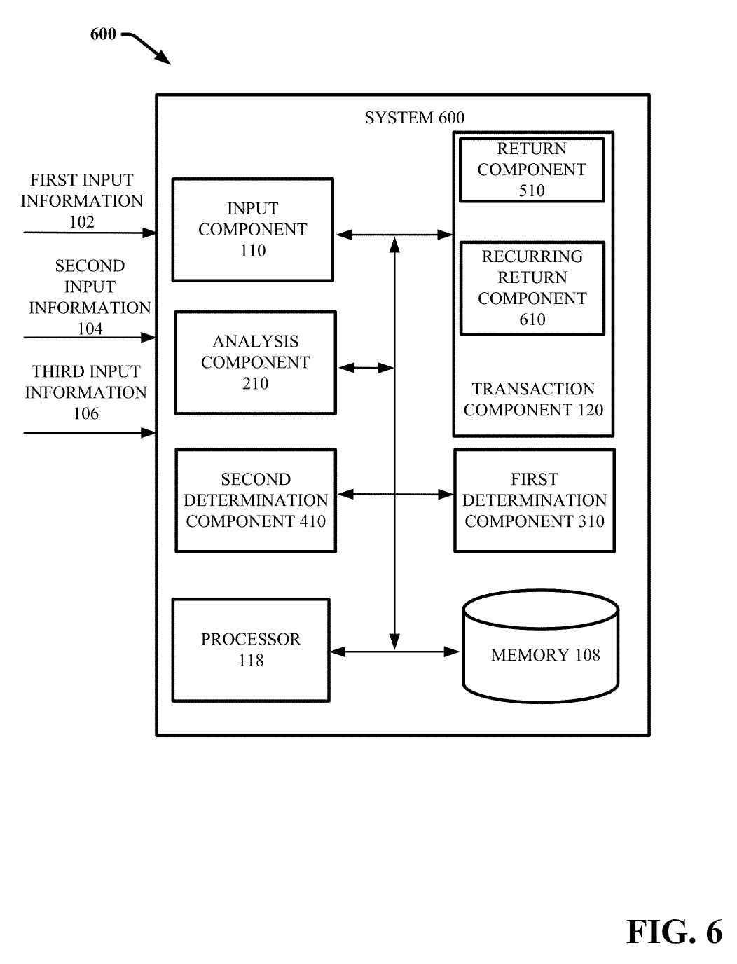

Turning now to FIG. 6, illustrated is system 600 in which an automated return or exchange system is described in accordance with one or more embodiments described herein. Repetitive description of like elements employed in other embodiments described herein are omitted for sake of brevity. In a non-limiting embodiment, system 600 can comprise an input component 110, a transaction component 120, an analysis component 210, a first determination component 310, a second determination component 410, a return component 510, and a recurring return component 610 that can perform another first version of the automatic return operation, another second version of the automatic return operation, or another third version of the automatic return operation based on the return component performing the first return operation and a residual refund amount remaining, wherein the residual refund amount is a difference between the first refund amount and a first payment amount, and wherein the second payment amount represents an amount paid for the second merchandise item.

In an aspect, recurring return component 610 can perform a return activity in an instance where the original merchandise item is more expensive than the new merchandise item exchanged or repurchased. In such instance, recurring return component 610 can refund the residual amount to a user account via a gift card, cash, check, reward points, or other refunding mechanism. In yet another aspect, where the new merchandise item is more expensive than the original merchandise item, the recurring return component 610 can employ a checkout confirmation feature that requires an additional payment in order to complete the transaction.

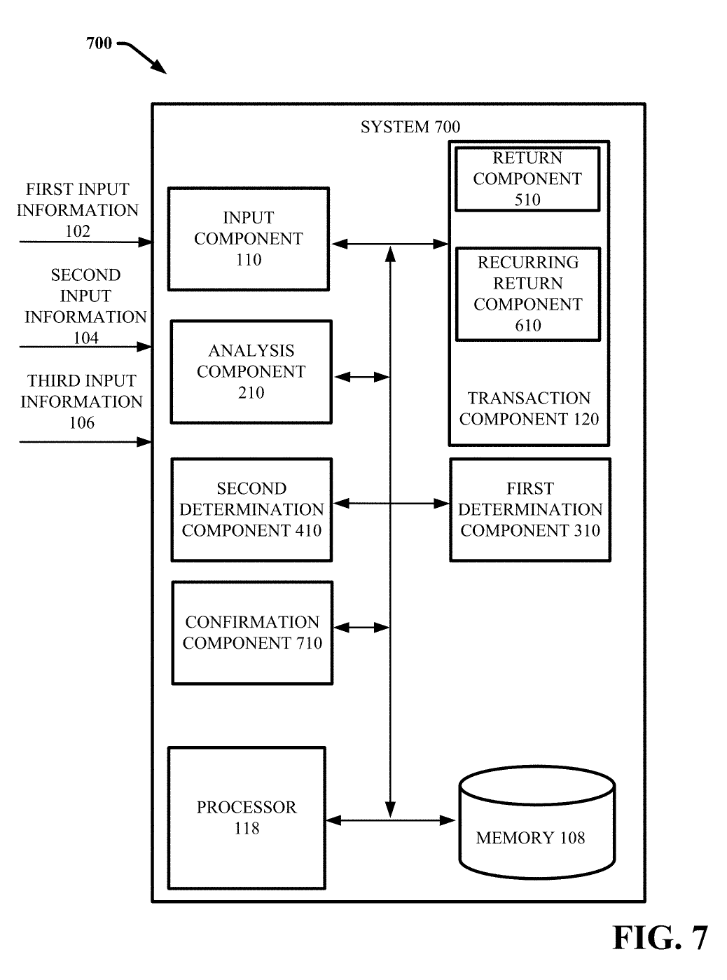

Turning now to FIG. 7, illustrated is system 700 in which an automated return or exchange system is described in accordance with one or more embodiments described herein. Repetitive description of like elements employed in other embodiments described herein are omitted for sake of brevity. In a non-limiting embodiment, system 700 can comprise an input component 110, a transaction component 120, an analysis component 210, a first determination component 310, a second determination component 410, a return component 510, a recurring return component 610, and a confirmation component 710 that can generate a confirmation of completion of the second return operation or the third return operation.

In an aspect, the confirmation component 710 can facilitate a confirmation of each actionable activity undertaken by the system. For instance, confirmation component 710 can request receipt of verification input data (e.g., a confirm click) to proceed to activate various operations. As such, system 100 can request confirmation data (e.g. using confirmation component 710) to confirm whether a user would like to use credit to shop for a new merchandise item, refund to a gift card, or refund to a credit card. Furthermore, upon a request to checkout and exchange a merchandise item, system 100 can request confirmation to proceed to billing a payment source. Furthermore, upon a user editing or changing details regarding an order, confirmation component 710 can require receipt of confirmation data before entering such change data. In yet another aspect, confirmation component 710 can request receipt of confirmation data prior to completing a refund (e.g., generating a shipping label for a package, billing a payment mechanism, etc.), shipping out a new material item, or performing an exchange operation.

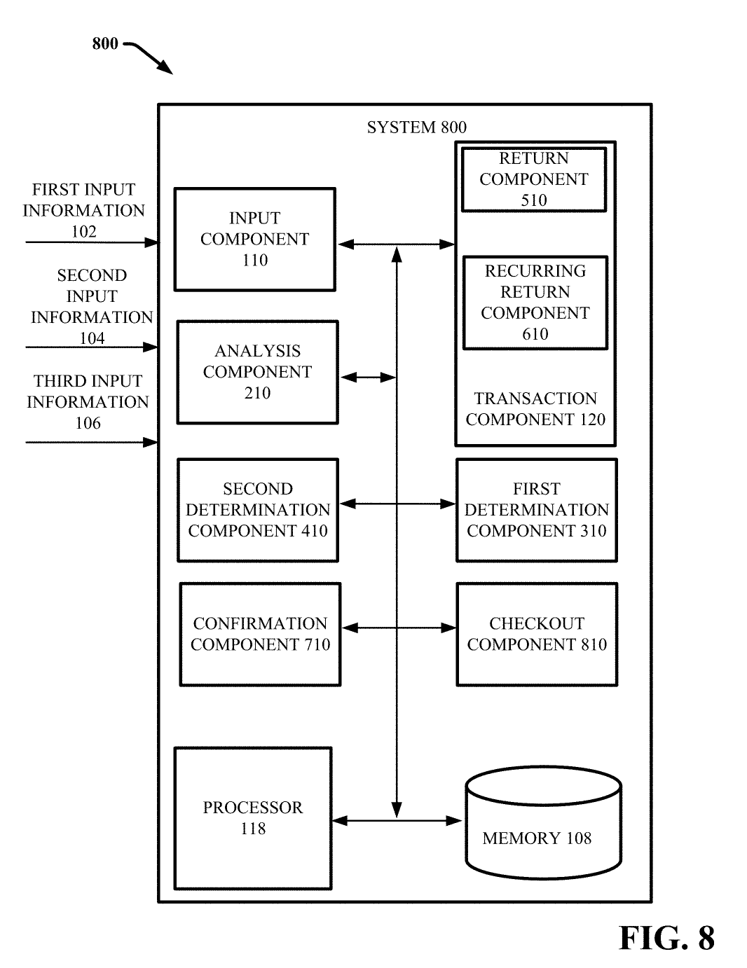

Turning now to FIG. 8, illustrated is system 800 in which an automated return or exchange system is described in accordance with one or more embodiments described herein. Repetitive description of like elements employed in other embodiments described herein are omitted for sake of brevity. In a non-limiting embodiment, system 800 can comprise an input component 110, a transaction component 120, an analysis component 210, a first determination component 310, a second determination component 410, a return component 510, a recurring return component 610, a confirmation component 710, and a checkout component 810 that can receive payment information associated with the second merchandise item, wherein the first refund amount is less than a second payment amount representing an amount paid for the second merchandise item.

In an aspect, the checkout component 810 facilitates the completion of an exchange operation and/or a refund operation. The checkout component 810 can facilitate a payment for any residual amount or refund of any amount owed based on a determination by second determination component 410. Furthermore, the checkout component 810 can provide a summary of the exchange order or refund order information (e.g., name, company, address, contact information, merchandise item exchanged or refunded, date etc.) to be displayed at a user interface. In an aspect, the checkout component 810 can provide a customized branding associated with the vendor's company to allow for a seamless user-customer experience. The customized branding can include company logo's, images designs, color schemes and other company identifiers that promote a user experience associated with the company. In yet another aspect, the checkout component 810 can employ security compliancy features to ensure the checkout experience promotes security protection and privacy protections for the user and vendor.

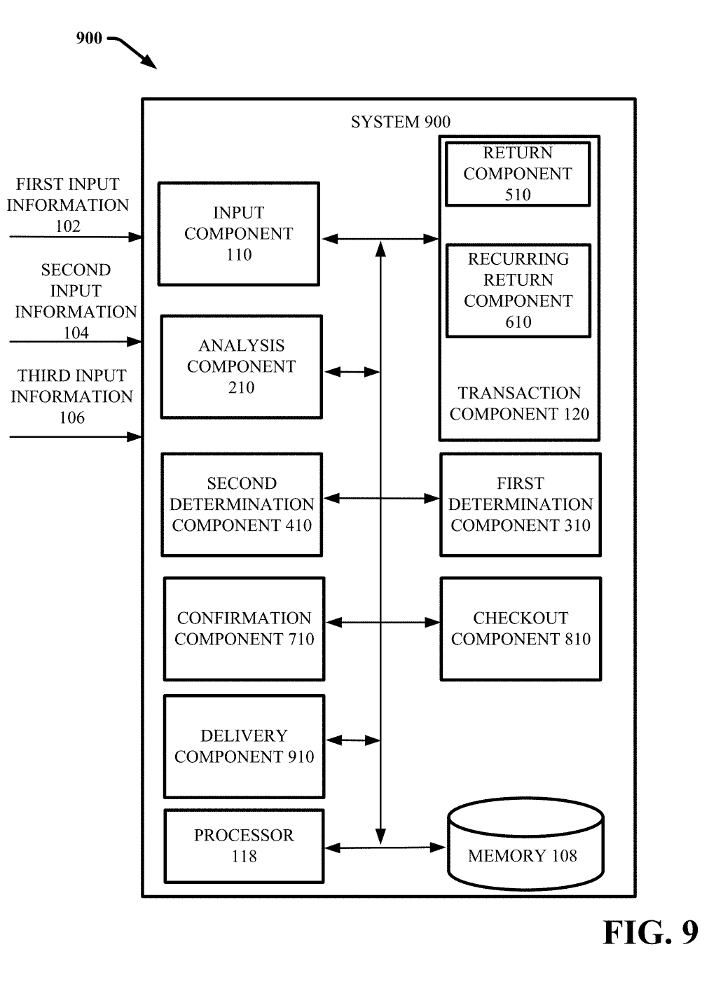

Turning now to FIG. 9, illustrated is system 900 in which an automated return or exchange system is described in accordance with one or more embodiments described herein. Repetitive description of like elements employed in other embodiments described herein are omitted for sake of brevity. In a non-limiting embodiment, system 900 can comprise an input component 110, a transaction component 120, an analysis component 210, a first determination component 310, a second determination component 410, a return component 510, a recurring return component 610, a confirmation component 710, a checkout component 810, and a delivery component 910 that can receive fourth input information representing an occurrence of an operation that facilitates sending the another first merchandise item or a second merchandise item to a first location based on receipt of the first merchandise item at a second location and a set of delivery criteria, wherein the first location and the second location are different.

In an aspect, delivery component 910 can facilitate the triggering of delivery mechanisms by communicating delivery data to the vendor and deliverers of merchandise items. For instance, delivery component 910 can transmit data to the vendor or shipping party that represents a date and time a package (e.g., comprising a merchandise item for return or exchange) has been picked-up for shipment to a delivery destination. Furthermore, delivery component 910 can transmit data corresponding to when a returned or exchanged merchandise item is received at a target destination (e.g., inventory warehouse). As such, upon the receipt of the exchanged or returned merchandise item, delivery component 910 can then trigger the delivery of a new merchandise item sought for exchange to a location associated with the user or customer. In another aspect, the delivery component 910 can also receive data related to transmission of a package throughout the course of shipment.

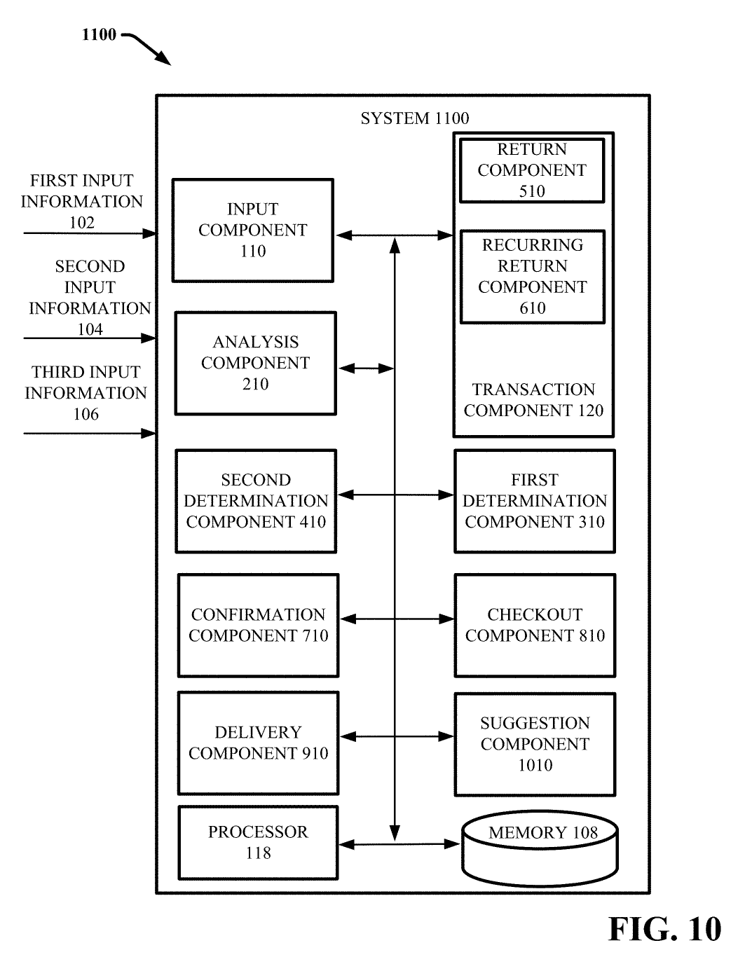

Turning now to FIG. 10, illustrated is system 1000 in which an automated return or exchange system is described in accordance with one or more embodiments described herein. Repetitive description of like elements employed in other embodiments described herein are omitted for sake of brevity. In a non-limiting embodiment, system 1000 can comprise an input component 110, a transaction component 120, an analysis component 210, a first determination component 310, a second determination component 410, a return component 510, a recurring return component 610, a confirmation component 710, a checkout component 810, a delivery component 910, and a suggestion component 1010 that can generate a suggested second merchandise item for an exchange with the first merchandise item based on at least one of a user preference information, predictive information, or the set of business criteria.

In an aspect, suggestion component 1010 can generate suggested merchandise items for exchange or return based on a user preference or purchase history data. For instance, a user exchanging a sweater, may seek to obtain the same sweater in the color blue given the users previous preference for blue apparel items. As such, system 1000 can employ suggestion component 1010 to generate suggested merchandise items for purchase or exchange. Furthermore, suggestion component 101 can utilize metadata associated with the merchandise items sought for exchange or return to facilitate a prediction of potential suggested items. The metadata can include, but is not limited to, a merchandise item title, category, keyword, description, tag, location, information about the vendor associated with the merchandise item, or other such information related to the merchandise item. In another aspect, suggestion component 1010 can also suggest complimentary or substitute merchandise items for a user consumption as well as items for exchange.

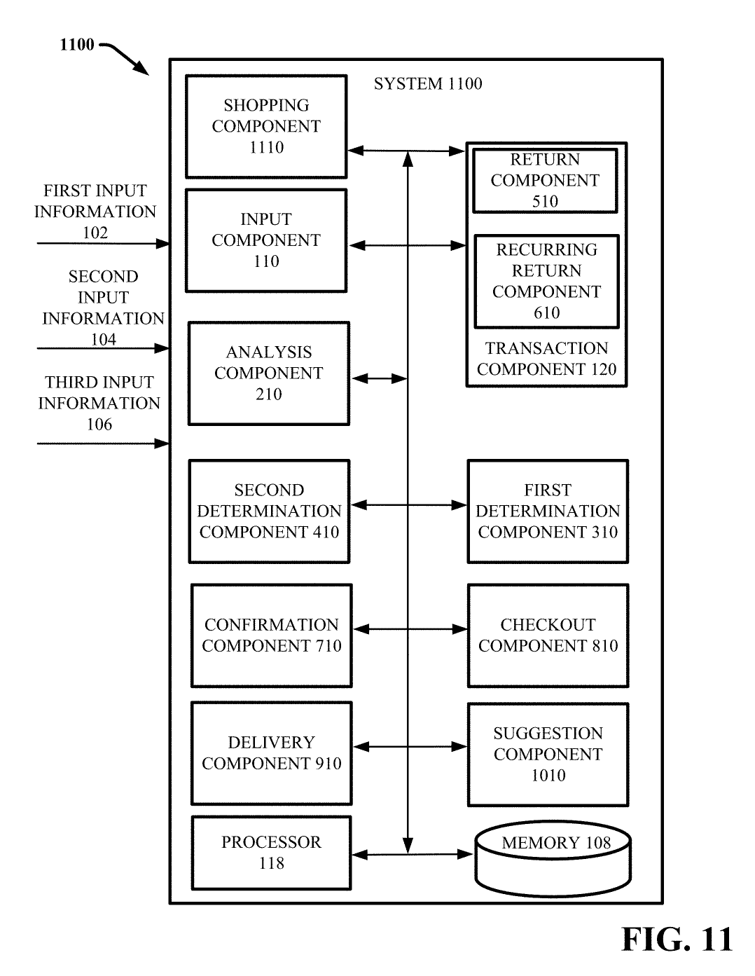

Turning now to FIG. 11, illustrated is system 1100 in which an automated return or exchange system is described in accordance with one or more embodiments described herein. Repetitive description of like elements employed in other embodiments described herein are omitted for sake of brevity. In a non-limiting embodiment, system 1100 can comprise an input component 110, a transaction component 120, an analysis component 210, a first determination component 310, a second determination component 410, a return component 510, a recurring return component 610, a confirmation component 710, a checkout component 810, a delivery component 910, a suggestion component 1010, and a shopping component 1110 that can deploy a shopping portal that facilitates a browsing operation and a selection operation of a set of merchandise items for selection in association with the automatic return operation or the automatic exchange operation. In an aspect, system 1100 can employ shopping component 1110 that can allow a user to seamlessly relocate from the return or exchange operation portal to the vendor's e-commerce web site and browse for merchandise items to purchase or select for an exchange. As such, the user can continue to possess an e-commerce experience in line with the vendor's intention.

In a non-limiting embodiment systems' 100-1200 can provide a variety of effective capabilities and features to vendors and consumers. For instance, a vendor can limit a line item eligibility of a merchandise item for refund or exchange using product tags, manage microcopy, identify a product as eligible for return only, identify a product as eligible for exchange only, manage the handling fee (e.g., deduct from eligible return balances for refunds, gift cards or product exchanges), manage qualitative feedback (e.g., reasons for returning a merchandise item) for each merchandise item, select validation attributes of merchandise item for refund or exchange (e.g., size and return for credit validate an eligible exchange item), edit header and sub-header messages, employ a live chat tool, establish analytics features, manage exchange or return policies (e.g., return eligibility, exchange eligibility, final sale items, line item restrictions), post rules for refunds or exchange orders, or perform other such activities.

In another instance, a customer or user can lookup an order securely, view items purchased, select (or unselect) exchange items, select (or unselect) return items, view an amount of credit for refund, select (or unselect) a refund for credit option, select (or unselect) an exchange option (e.g., new size apparel item), shop a vendor website with remaining credit, elect to continue a return, browse a vendor website, view available credit, return to an exchange application, select an item for purchase with some or all of the return credit, elect to refund the credit to a credit card or gift card (e.g., gift card to an e-commerce store), view returned items, review items received in exchange, review a credit amount to receive in exchange for a return, edit a return or exchange, submit a return or exchange, confirm a refund has been completed, print a return shipping label, confirm a return shipping label has been e-mailed, confirm items required for inclusion in a return, can continue to browse and shop using a vendor website after a return or exchange operation is completed, or perform other such activities.

In another non-limiting embodiment, a user can utilize systems 100-1200 by entering order detail data at a user interface where such data is received at input component 110. Furthermore, analysis component 110 can determine whether the input information satisfies a vendor's business rules, if the rules are not satisfied then the system notifies the user via the user interface. If the input information satisfies the vendors business rules, then the input component 110 receives further data relating to a selected merchandise item. The selected merchandise item can be determined (using first determination component 310) to be eligible or ineligible for a return or exchange. If the input component 110 receives data associated with a requested return operation, then transaction component 120 can employ return component to implement a return operation 510. If the input component 110 receives data associated with a requested exchange operation, then return component 510 performs an exchange.

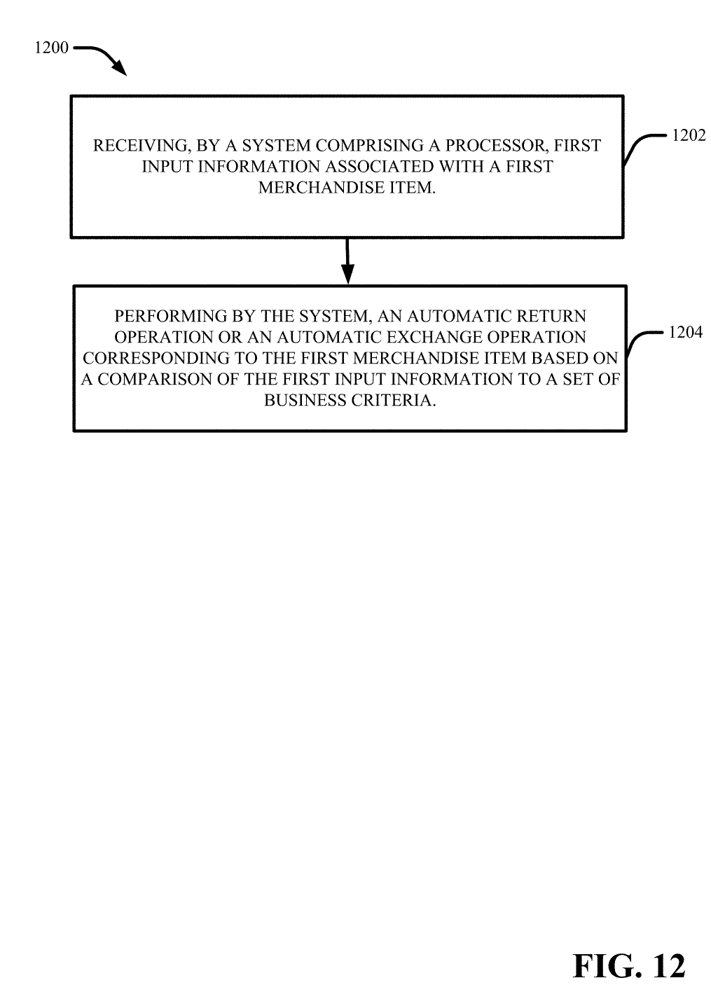

FIG. 12 illustrates a flow diagram of an example, non-limiting computer-implemented method 1200 that can facilitate an automated return or exchange operation in accordance with a system. Repetitive description of like elements employed in other embodiments described herein is omitted for sake of brevity. In some implementations, at reference numeral 1202, a system operatively coupled to a processor (e.g., processor 118) can receive (e.g., using input component 110) first input information associated with a first merchandise item. At reference numeral 1204, the system can perform (e.g., using transaction component 120) an automatic return operation or an automatic exchange operation corresponding to the first merchandise item based on a comparison of the first input information to a set of business criteria.

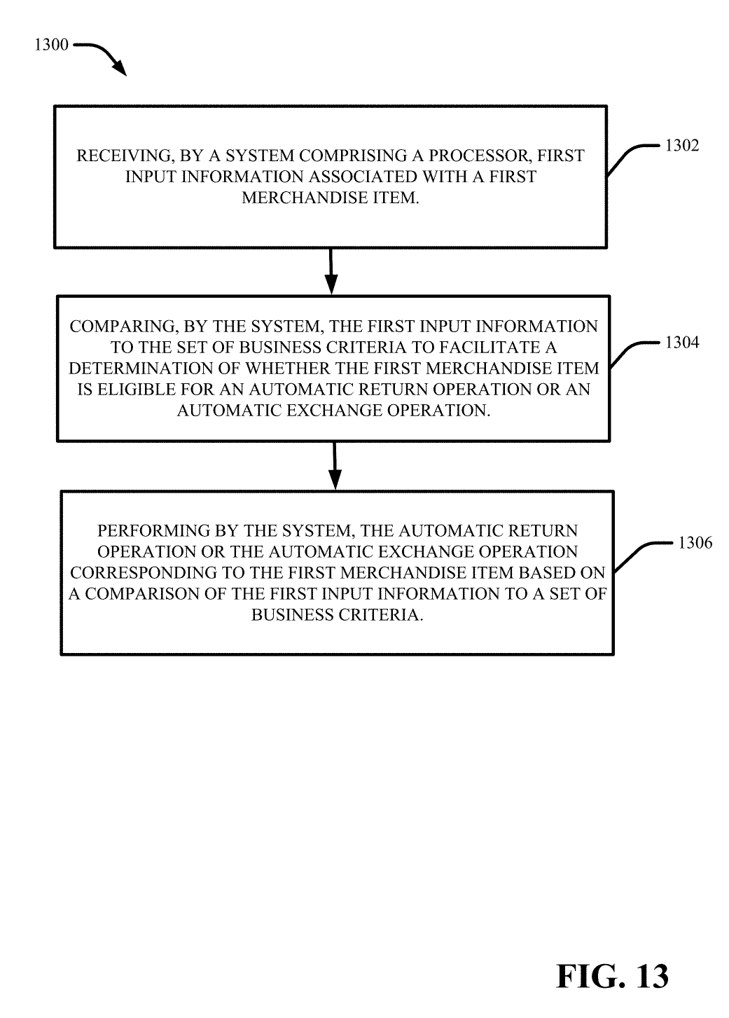

FIG. 13 illustrates a flow diagram of an example, non-limiting computer-implemented method 1300 that can facilitate an automated return or exchange operation in accordance with a system. Repetitive description of like elements employed in other embodiments described herein is omitted for sake of brevity. In some implementations, at reference numeral 1302, a system operatively coupled to a processor (e.g., processor 118) can receive (e.g., using input component 110) first input information associated with a first merchandise item. At reference numeral 1304, the system can compare (e.g., using analysis component 210) the first input information to the set of business criteria to facilitate a determination of whether the first merchandise item is eligible for the automatic return operation or the automatic exchange operation. At reference numeral 1306, the system can perform (e.g., using transaction component 120) an automatic return operation or an automatic exchange operation corresponding to the first merchandise item based on a comparison of the first input information to a set of business criteria.

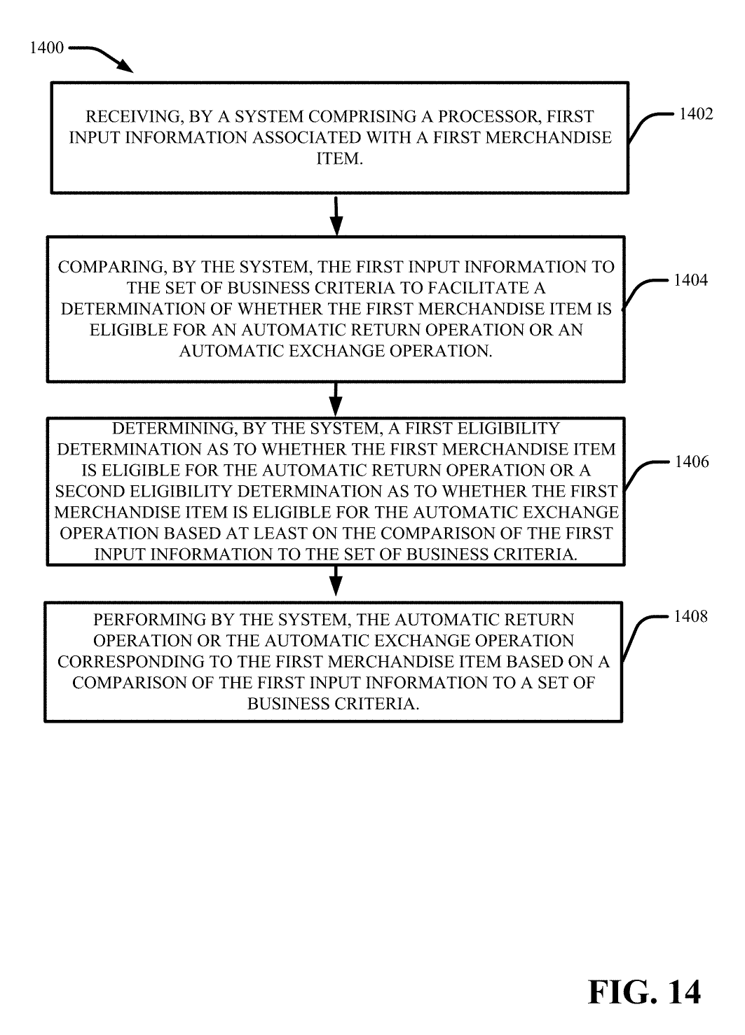

FIG. 14 illustrates a flow diagram of an example, non-limiting computer-implemented method 1400 that can facilitate an automated return or exchange operation in accordance with a system. Repetitive description of like elements employed in other embodiments described herein is omitted for sake of brevity. In some implementations, at reference numeral 1402, a system operatively coupled to a processor (e.g., processor 118) can receive (e.g., using input component 110) first input information associated with a first merchandise item. At reference numeral 1404, the system can compare (e.g., using analysis component 210) the first input information to the set of business criteria to facilitate a determination of whether the first merchandise item is eligible for the automatic return operation or the automatic exchange operation.

At reference numeral 1406, the system can determine (e.g., using first determination component 310) a first eligibility determination as to whether the first merchandise item is eligible for the automatic return operation or a second eligibility determination as to whether the first merchandise item is eligible for the automatic exchange operation based at least on the comparison of the first input information to the set of business criteria. At reference numeral 1408, the system can perform (e.g., using transaction component 120) an automatic return operation or an automatic exchange operation corresponding to the first merchandise item based on a comparison of the first input information to a set of business criteria.

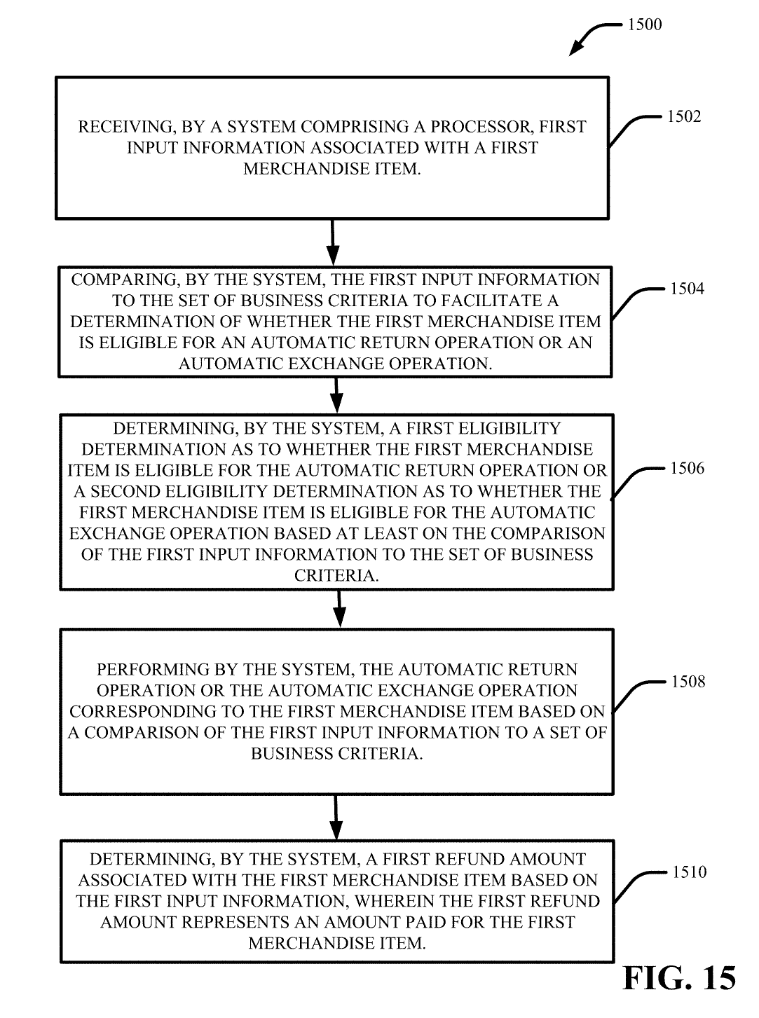

FIG. 15 illustrates a flow diagram of an example, non-limiting computer-implemented method 1500 that can facilitate an automated return or exchange operation in accordance with a system. Repetitive description of like elements employed in other embodiments described herein is omitted for sake of brevity. In some implementations, at reference numeral 1502, a system operatively coupled to a processor (e.g., processor 118) can receive (e.g., using input component 110) first input information associated with a first merchandise item. At reference numeral 1504, the system can compare (e.g., using analysis component 210) the first input information to the set of business criteria to facilitate a determination of whether the first merchandise item is eligible for the automatic return operation or the automatic exchange operation.

At reference numeral 1506, the system can determine (e.g., using first determination component 310) a first eligibility determination as to whether the first merchandise item is eligible for the automatic return operation or a second eligibility determination as to whether the first merchandise item is eligible for the automatic exchange operation based at least on the comparison of the first input information to the set of business criteria. At reference numeral 1508, the system can perform (e.g., using transaction component 120) an automatic return operation or an automatic exchange operation corresponding to the first merchandise item based on a comparison of the first input information to a set of business criteria. At reference numeral 1510, the system can determine (e.g., using second determination component 410) a first refund amount associated with the first merchandise item based on the first input information, wherein the first refund amount represents an amount paid for the first merchandise item.

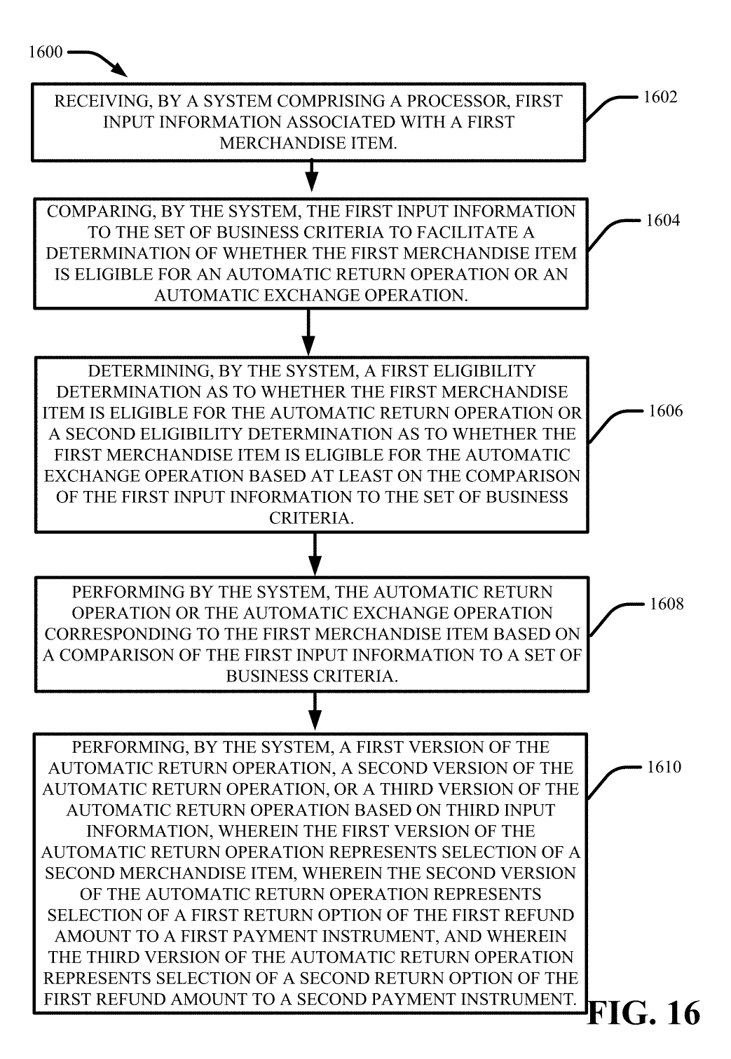

FIG. 16 illustrates a flow diagram of an example, non-limiting computer-implemented method 1600 that can facilitate an automated return or exchange operation in accordance with a system. Repetitive description of like elements employed in other embodiments described herein is omitted for sake of brevity. In some implementations, at reference numeral 1602, a system operatively coupled to a processor (e.g., processor 118) can receive (e.g., using input component 110) first input information associated with a first merchandise item. At reference numeral 1604, the system can compare (e.g., using analysis component 210) the first input information to the set of business criteria to facilitate a determination of whether the first merchandise item is eligible for the automatic return operation or the automatic exchange operation.

At reference numeral 1606, the system can determine (e.g., using first determination component 310) a first eligibility determination as to whether the first merchandise item is eligible for the automatic return operation or a second eligibility determination as to whether the first merchandise item is eligible for the automatic exchange operation based at least on the comparison of the first input information to the set of business criteria. At reference numeral 1608, the system can perform (e.g., using transaction component 120) an automatic return operation or an automatic exchange operation corresponding to the first merchandise item based on a comparison of the first input information to a set of business criteria.

At reference numeral 1610, the system can perform (e.g., using return component 510) a first version of the automatic return operation, a second version of the automatic return operation, or a third version of the automatic return operation based on third input information, wherein the first version of the automatic return operation represents selection of a second merchandise item, wherein the second version of the automatic return operation represents selection of a first return option of the first refund amount to a first payment instrument, and wherein the third version of the automatic return operation represents selection of a second return option of the first refund amount to a second payment instrument.

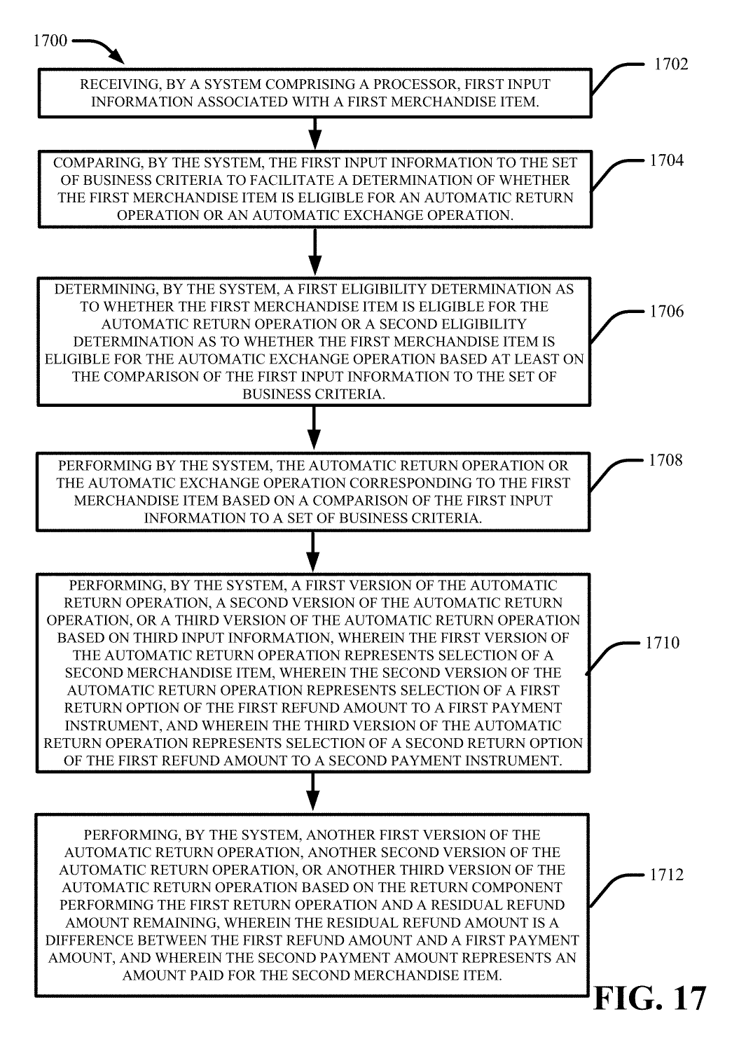

FIG. 17 illustrates a flow diagram of an example, non-limiting computer-implemented method 1700 that can facilitate an automated return or exchange operation in accordance with a system. Repetitive description of like elements employed in other embodiments described herein is omitted for sake of brevity. In some implementations, at reference numeral 1702, a system operatively coupled to a processor (e.g., processor 118) can receive (e.g., using input component 110) first input information associated with a first merchandise item. At reference numeral 1704, the system can compare (e.g., using analysis component 210) the first input information to the set of business criteria to facilitate a determination of whether the first merchandise item is eligible for the automatic return operation or the automatic exchange operation.

At reference numeral 1706, the system can determine (e.g., using first determination component 310) a first eligibility determination as to whether the first merchandise item is eligible for the automatic return operation or a second eligibility determination as to whether the first merchandise item is eligible for the automatic exchange operation based at least on the comparison of the first input information to the set of business criteria. At reference numeral 1708, the system can perform (e.g., using transaction component 120) an automatic return operation or an automatic exchange operation corresponding to the first merchandise item based on a comparison of the first input information to a set of business criteria.

At reference numeral 1710, the system can perform (e.g., using return component 510) a first version of the automatic return operation, a second version of the automatic return operation, or a third version of the automatic return operation based on third input information, wherein the first version of the automatic return operation represents selection of a second merchandise item, wherein the second version of the automatic return operation represents selection of a first return option of the first refund amount to a first payment instrument, and wherein the third version of the automatic return operation represents selection of a second return option of the first refund amount to a second payment instrument. At reference numeral 1712, the system can perform (e.g., using a recurring return component 610) another first version of the automatic return operation, another second version of the automatic return operation, or another third version of the automatic return operation based on the return component performing the first return operation and a residual refund amount remaining, wherein the residual refund amount is a difference between the first refund amount and a first payment amount, and wherein the second payment amount represents an amount paid for the second merchandise item.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art can understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

Moreover, because simulation of a first vehicle braking system in a second vehicle braking system is performed by components executed by a processor (e.g., processor 118) established from a combination of electrical and mechanical components and circuitry, a human is unable to replicate or perform the subject data packet configuration and/or the subject communication between processing components and/or a determination component. Furthermore, vehicle data associated with the first braking system is generated, transformed, and mapped to a second vehicle braking system. The access to such vehicle data is accessed from a memory (e.g., using memory 108) where such access patterns a human are unable to replicate.

Also, the systems and methods disclosed herein can be integrated with the tangible and physical computing systems and e-commerce systems of various vendors, companies, and third party institutions. Furthermore, the automated exchange and return operations in connection with shipping activities and consumer real-time information acquisition cannot be performed by a human. For example, a human is unable to generate learned data from a delivery system, learn a data-driven purchasing, exchange, or return preference of one or more users, accurately and precisely. Furthermore, a human is unable to communicate exchange, return, or shipping data and/or packetized data for communication between a main processor (e.g., using processor 118) and a memory (e.g., memory 108) as well as efficient access from a memory or database. In another aspect, systems and method described herein can be implemented using artificial intelligence, machine learning, and/or deep learning techniques to facilitate more timely and efficacious return and/or exchange processes that a human is unable to perform.

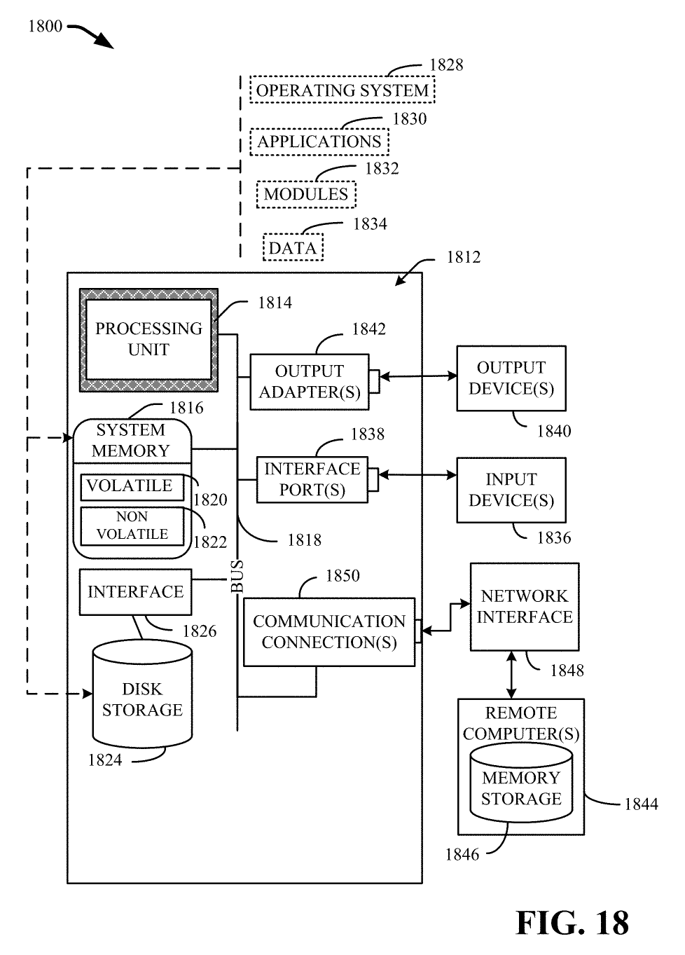

In order to provide a context for the various aspects of the disclosed subject matter, FIG. 18 as well as the following discussion is intended to provide a general description of a suitable environment in which the various aspects of the disclosed subject matter can be implemented. FIG. 18 illustrates a block diagram of an example, non-limiting operating environment in which one or more embodiments described herein can be facilitated. With reference to FIG. 18, a suitable operating environment 1800 for implementing various aspects of this disclosure can also include a computer 1812. The computer 1812 can also include a processing unit 1814, a system memory 1816, and a system bus 1818. The system bus 1818 couples system components including, but not limited to, the system memory 1816 to the processing unit 1814. The processing unit 1814 can be any of various available processors. Dual microprocessors and other multiprocessor architectures also can be employed as the processing unit 1814. The system bus 1818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1816 can also include volatile memory 1820 and nonvolatile memory 1822. The basic input/output system (BIOS), containing the basic routines to transfer information between elements within the computer 1812, such as during start-up, is stored in nonvolatile memory 1822. By way of illustration, and not limitation, nonvolatile memory 1822 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1820 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1812 can also include removable/non-removable, volatile/non-volatile computer storage media. FIG. 18 illustrates, for example, a disk storage 1824. Disk storage 1824 can also include, but is not limited to, devices like a magnetic disk drive, floppy disk drive, tape drive, Jaz drive, Zip drive, LS-100 drive, flash memory card, or memory stick. The disk storage 1824 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1824 to the system bus 1818, a removable or non-removable interface is typically used, such as interface 1826. FIG. 18 also depicts software that acts as an intermediary between users and the basic computer resources described in the suitable operating environment 1800. Such software can also include, for example, an operating system 1828. Operating system 1828, which can be stored on disk storage 1824, acts to control and allocate resources of the computer 1812.

System applications 1830 take advantage of the management of resources by operating system 1828 through program modules 1832 and program data 1834, e.g., stored either in system memory 1816 or on disk storage 1824. It is to be appreciated that this disclosure can be implemented with various operating systems or combinations of operating systems. A user enters commands or information into the computer 1812 through input device(s) 1836. Input devices 1836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1814 through the system bus 1818 via interface port(s) 1838. Interface port(s) 1838 include, for example, a serial port, a parallel port, a game port, and a universal serial bus (USB). Output device(s) 1840 use some of the same type of ports as input device(s) 1836. Thus, for example, a USB port can be used to provide input to computer 1812, and to output information from computer 1812 to an output device 1840. Output adapter 1842 is provided to illustrate that there are some output devices 1840 like monitors, speakers, and printers, among other output devices 1840, which require special adapters. The output adapters 1842 include, by way of illustration and not limitation, video and sound cards that provide a means of connection between the output device 1840 and the system bus 1818. It should be noted that other devices and/or systems of devices provide both input and output capabilities such as remote computer(s) 1844.

Computer 1812 can operate in a networked environment using logical connections to one or more remote computers, such as remote computer(s) 1844. The remote computer(s) 1844 can be a computer, a server, a router, a network PC, a workstation, a microprocessor based appliance, a peer device or other common network node and the like, and typically can also include many or all of the elements described relative to computer 1812. For purposes of brevity, only a memory storage device 1846 is illustrated with remote computer(s) 1844. Remote computer(s) 1844 is logically connected to computer 1812 through a network interface 1848 and then physically connected via communication connection 1850. Network interface 1848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1850 refers to the hardware/software employed to connect the network interface 1848 to the system bus 1818. While communication connection 1850 is shown for illustrative clarity inside computer 1812, it can also be external to computer 1812. The hardware/software for connection to the network interface 1848 can also include, for exemplary purposes only, internal and external technologies such as, modems including regular telephone grade modems, cable modems and DSL modems, ISDN adapters, and Ethernet cards.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory that stores computer executable components;
a processor that executes computer executable components stored in the memory, wherein the computer executable components comprise:
an input component that receives first input information associated with a first merchandise item; and
a transaction component that performs an automatic return operation or an automatic exchange operation corresponding to the first merchandise item based on a comparison of the first input information to a set of business criteria.

2. The system of claim 1, further comprising an analysis component that compares the first input information to the set of business criteria to facilitate a determination of whether the first merchandise item is eligible for the automatic return operation or the automatic exchange operation.

3. The system of claim 2, further comprising a first determination component that determines a first eligibility determination as to whether the first merchandise item is eligible for the automatic return operation or a second eligibility determination as to whether the first merchandise item is eligible for the automatic exchange operation based the comparison of the first input information to the set of business criteria.

4. The system of claim 3, wherein the transaction component performs the automatic return operation based on the first eligibility determination of the first merchandise item and second input information.

5. The system of claim 3, wherein the transaction component performs the automatic exchange operation based on the second eligibility determination of the first merchandise item and third input information corresponding to another first merchandise item.

6. The system of claim 4, further comprising a second determination component that determines a first refund amount associated with the first merchandise item based on the first input information, wherein the first refund amount represents an amount paid for the first merchandise item.

7. The system of claim 6, wherein the transaction component employs a return component that performs a first version of the automatic return operation, a second version of the automatic return operation, or a third version of the automatic return operation based on third input information, wherein the first version of the automatic return operation represents selection of a second merchandise item, wherein the second version of the automatic return operation represents selection of a first return option of the first refund amount to a first payment instrument, and wherein the third version of the automatic return operation represents selection of a second return option of the first refund amount to a second payment instrument.

8. The system of claim 7, wherein the first payment instrument is a gift card, and wherein the second payment instrument is a credit card.

9. The system of claim 7, wherein the transaction component employs a recurring return component that performs another first version of the automatic return operation, another second version of the automatic return operation, or another third version of the automatic return operation based on the return component performing the first return operation and a residual refund amount remaining, wherein the residual refund amount is a difference between the first refund amount and a first payment amount, and wherein the second payment amount represents an amount paid for the second merchandise item.

10. The system of claim 7, further comprising a confirmation component that generates a confirmation of completion of the second return operation or the third return operation.

11. The system of claim 7, further comprising a checkout component that receives payment information associated with the second merchandise item, wherein the first refund amount is less than a second payment amount representing an amount paid for the second merchandise item.

12. The system of claim 5, wherein the automatic exchange operation facilitates an exchange of the first merchandise item for the another merchandise item.

13. The system of claim 1, further comprising a delivery component that receives fourth input information representing an occurrence of an operation that facilitates sending the another first merchandise item or a second merchandise item to a first location based on receipt of the first merchandise item at a second location and a set of delivery criteria, wherein the first location and the second location are different.

14. The system of claim 1, further comprising a suggestion component that generates a suggested second merchandise item for an exchange with the first merchandise item based on at least one of user preference information, predictive information, or the set of business criteria.

15. The system of claim 1, further comprising a shopping component that deploys a shopping portal that facilitates a browsing operation and a selection operation of a set of merchandise items for selection in association with the automatic return operation or the automatic exchange operation.

16. A method comprising:
receiving, by a system comprising a processor, first input information associated with a first merchandise item; and
performing, by the system, an automatic return operation or an automatic exchange operation corresponding to the first merchandise item based on a comparison of the first input information to a set of business criteria.

17. The method of claim 16, further comprising comparing, by the system, the first input information to the set of business criteria to facilitate a determination of whether the first merchandise item is eligible for the automatic return operation or the automatic exchange operation.

18. The method of claim 17, further comprising determining, by the system, a first eligibility determination as to whether the first merchandise item is eligible for the automatic return operation or a second eligibility determination as to whether the first merchandise item is eligible for the automatic exchange operation based at least on the comparison of the first input information to the set of business criteria.

19. The method of claim 18, further comprising determining, by the system, a first refund amount associated with the first merchandise item based on the first input information, wherein the first refund amount represents an amount paid for the first merchandise item.

20. A computer program product for facilitating a return or exchange transaction corresponding to one or more devices, the computer program product comprising a computer readable storage medium having program instructions embodied therewith, the program instructions executable by a processor to cause the processor to:
receive first input information associated with a first merchandise item; and
perform an automatic return operation or an automatic exchange operation corresponding to the first merchandise item based on a comparison of the first input information to a set of business criteria.
